(19) United States
(12) Patent Application Publication
(10) Pub. No.: US 2018/0082703 A1
(43) Pub. Date: Mar. 22, 2018

(54) SUITABILITY SCORE BASED ON ATTRIBUTE SCORES

(71) Applicant: LONGSAND LIMITED, Cambridge (GB)

(72) Inventors: Abigail Betley, London (GB); David Pye, Cambridge (GB)

(21) Appl. No.: 15/566,886

(22) PCT Filed: Apr. 30, 2015
(86) PCT No.: PCT/EP2015/059583

§ 371 Date: Oct. 16, 2017

(51) Int. Cl. G10L 25/60; G10L 15/01; G10L 25/30; G10L 15/22

(52) U.S. Cl. CPC G10L 25/60; G10L 15/01; G10L 2015/225; G10L 15/22; G10L 25/30

(57) ABSTRACT

A plurality of attribute scores are calculated for data including audio based on a plurality of acoustic attributes. Each of the attribute scores relate to a detection of one of the acoustic attributes in the data including audio. A suitability score is output based on the plurality of attribute scores. The suitability score relates to an accuracy of a speech recognition system to transcribe the data including audio.

### BACKGROUND

With the recent improvements in speech recognition technology, speech recognition technologies are being increasingly applied to a diverse array of audio and video content. Providers of such speech recognition technology are challenged to provide increasingly more accurate speech translation for their clients.

### BRIEF DESCRIPTION OF THE DRAWINGS

The following detailed description references the drawings, wherein:

FIG. 1 is an example block diagram of a device to output a suitability score based on attribute scores;

FIG. 2 is another example block diagram of a device to output a suitability score based on attribute scores;

FIG. 3 is an example block diagram of a computing device including instructions for outputting a suitability score based on attribute scores; and

FIG. 4 is an example flowchart of a method for outputting a suitability score based on attribute scores.

### DETAILED DESCRIPTION

Specific details are given in the following description to provide a thorough understanding of embodiments. However, it will be understood that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

Commonly, speech recognition technologies are being applied to content ranging from broadcast quality news clips to poor quality voicemails as well as home-made videos, commonly recorded on smartphones. The corresponding accuracy of speech recognition technologies may vary significantly depending on the type of content to which it is applied. However, users are often unaware of how, what and why acoustic features affect the speech recognition accuracy, which leads to inaccurate expectations of performance.

The user may be able to listen to the content and make their own opinion on speech recognition suitability, but this is subjective and often does not correlate with the performance of the speech recognition technology. Alternatively, it may be possible for the user to extrapolate a score from the amount of acoustic features, but this may require specialist knowledge and may be cumbersome. Generally, users do not have knowledge of the workings of speech recognition technologies and/or the affect of acoustic features on them.

Examples may automatically provide a score for audio and video content, which correlates to its suitability for machine speech recognition. An example device may include an attribute unit and a suitability unit. The attribute unit may calculate a plurality of attribute scores for data including audio based on a plurality of acoustic attributes. Each of the attribute scores may relate to a detection of one of the acoustic attributes in the data including audio. The suitability unit may output an accuracy score based on the plurality of attribute scores. The suitability score may relate to an accuracy of a speech recognition system to transcribe the data including audio.

Examples may ascertain the amount of acoustic features and combine them intelligently with other acoustic metrics to provide a rating. Thus, examples may intelligently combine acoustic features and metrics and automatically provide a simple to understand score or rating.

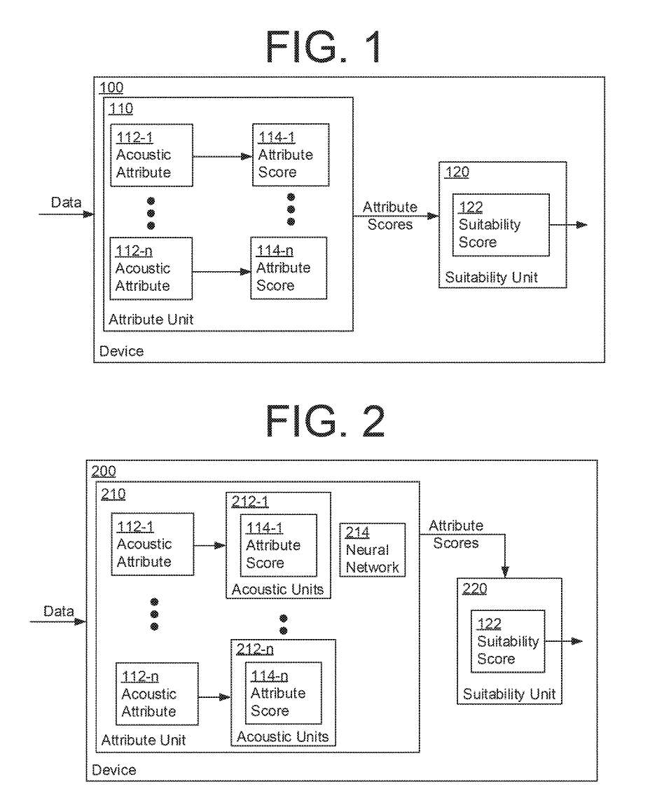

Referring now to the drawings, FIG. 1 is an example block diagram of a device to output a suitability score based on attribute scores. The device 100 may include or be part of a microprocessor, a controller, a memory module or device, a notebook computer, a desktop computer, an all-in-one system, a server, a network device, a wireless device, an audio device and the like. For instance, the device 100 may be connected to a microphone (not shown).

The device 100 is shown to include an attribute unit 110 and a suitability unit 120. The attribute and suitability units 110 and 120 may include, for example, a hardware device including electronic circuitry for implementing the functionality described below, such as control logic and/or memory. In addition or as an alternative, the attribute and suitability units 110 and 120 may be implemented as a series of instructions encoded on a machine-readable storage medium and executable by a processor.

The attribute unit 110 may calculate a plurality of attribute scores 114-1 to 114-n, where n is natural number, for data including audio based on a plurality of acoustic attributes 112-1 to 112-n. Each of the attribute scores 114-1 to 114-n may relate to a detection of one of the acoustic attributes 112-1 to 112-n in the data including audio. The suitability unit 120 may output a suitability score 122 based on the plurality of attribute scores 114-1 to 114-n. The suitability score 122 may relate to an accuracy of a speech recognition system to transcribe the data including audio. The device 100 is explained in greater detail below with respects to FIGS. 2-4.

FIG. 2 is another example block diagram of a device 200 to output a suitability score based on attribute scores. The device 200 may include or be part of a microprocessor, a controller, a memory module or device, a notebook computer, a desktop computer, an all-in-one system, a server, a network device, a wireless device, an audio device and the like.

The device 200 of FIG. 2 may include at least the functionality and/or hardware of the device 100 of FIG. 1. For example, device 200 of FIG. 2 includes an attribute unit 210 and a suitability unit 210 that respectively includes the functionality and/or hardware of the attribute and suitability units 110 and 120 of device 100 of FIG. 1.

The attribute unit 210 may receive data including audio, such as video or audio segment like a TV show or radio clip. The data may be received, for example, from a file, from a stream, and/or through a variety of mechanisms. As noted above, the attribute unit 210 may calculate a plurality of attribute scores 114-1 to 114-n, where n is natural number, for the data including audio based on a plurality of acoustic attributes 112-1 to 112-n. Each of the attribute scores 114-1 to 114-n may relate to a detection of one of the acoustic attributes 112-1 to 112-n in the data including audio.

The plurality of acoustic attributes 112-1 to 112-n, may relate, for example an amount of bandwidth, clipping of an audio wave, music, speech, background noise, reverberation, a signal-to-noise ratio (SNR) and the like. A higher value for any of the attribute scores 114-1 to 114-n indicates a greater amount of the corresponding acoustic attribute 112. For example, an attribute score of 5 may indicate a greater amount of the corresponding acoustic attribute than an attribute score of 1.

The acoustic attribute 112 related to SNR may measure a ratio of an audio level of speech in decibels compared to a level of background noise. Good clean audio with true silence in the background may have a high attribute score 114 related to SNR. Similarly, music and/or noise content of the background may be measured in a variety of ways and produce various attribute scores 114.

The acoustic attribute 112 related to audio clipping may measure a percentage of the waveform that is affected by clipping. Audio clipping may be damaging to speech-to-text performance. This may be due to problems with recording levels, where a resulting digital waveform exceeds a maximum (or minimum) sample value, thus causing audible distortion. The percentage of the waveform that is affected by clipping may be estimated and converted into an attribute score 114.

The acoustic attribute 112 related to audio bandwidth may measure bitrate, an amount of compression, upsampling, an amount of lower bandwidth compared within a greater bandwidth audio sample and/or the like. For example, lossy compression may have a higher attribute score 114 than lossless compression. Also, a greater amount of lower bandwidth or bitrate data within a greater bandwidth audio sample may result in a greater attribute score 114. Thus, audio bandwidth issues may also affect recognition quality. For instance, the amount and quantity of low-bandwidth phone calls within a wideband TV or Radio broadcast may be calculated to produce an attribute score 114.

Upsampling may refer to interpolation, applied in the context of digital signal processing and sample rate conversion. When upsampling is performed on a sequence of samples of a continuous function or signal, it produces an approximation of the sequence that would have been obtained by sampling the signal at a higher rate. Here, a greater factor of upsampling may result in a greater attribute score 114. For instance, an audio file recorded at 11025 Hz may be up-sampled to 16 kHz for recognition, but may not achieve a same quality of recognition as a native 16 kHz recording. Other acoustic attributes 112 may relate to the amount of reverberation (echo), a far-field recording, the talking rate of the speaker, and the like.

The acoustic attribute 112 related to speech may measure a type of language detected, a type of accent of a speaker and/or like. Certain types of languages or accents that are more difficult to transcribe may result in a greater attribute score 114. For instance, how amenable the speaker's accent is to recognition or whether the utterance is recorded with a single and homogeneous language may be determined to calculate the attribute score 114.

There are many other potential criteria (e.g. acoustic attributes 112) on which data including audio may be judged. Examples may take into account many or more or less types of acoustic attributes 112 to produce various other attribute scores 114. Any of the above attributes scores 114, may be calculated based on a scale, such as from 1 to 5. Here, it may be assumed an attribute score 114 of 1.0 represents good audio and an attribute score 114 of 5.0 represents maximally problematic audio.

The attribute unit 210 may identify the plurality of acoustic attributes 112-1 to 112-n within the data including the audio based various types of recognition systems, such as via a plurality of acoustic units 212-1 to 212-n and/or a neural network 214. The neural network 214 may be an artificial neural network generally presented as systems of interconnected “neurons” which can compute values from inputs, and are capable of machine learning as well as pattern recognition thanks to their adaptive nature. The plurality of acoustic units 212-1 to 212-n may include, for example, a hardware device including electronic circuitry for implementing the functionality described below, such as control logic and/or memory. In addition or as an alternative, the plurality of acoustic units 212-1 to 212-n may be implemented as a series of instructions encoded on a machine-readable storage medium and executable by a processor.

Each of the plurality of acoustic units 212-1 to 212-n may identify one of the acoustic attributes 112 and may output the attribute score 114 based on an amount of the corresponding acoustic attribute 112 that is identified, such as explained above. Thus, each of the plurality of acoustic units 212-1 to 212-n may be trained to identify a different type of acoustic attribute 112.

A large corpus of varied and representative audio waveforms may be used for training a neural network. Each of these training waveforms may be sufficiently small to be homogenous in character and be labelled with a suitability score 122. This suitability score 122 can be derived by a heuristic approach, by human judgment or Speech-to-text if the true transcript is known. The neural network 214 (or similar) may be designed and trained with inputs corresponding to a sequence of acoustic feature vectors and various outputs, one for each potential suitability score 122.

The process of estimating the suitability score 122 may therefore involve converting a audio waveform into a time sequence of Acoustic Feature Vectors by the attribute unit 210, feeding this as input into a neural network 214 and directly producing the suitability score 122 as output at periodic time intervals. Examples may identify acoustic attributes 112 based on other types of speech recognition systems as well, such as a Hidden Markov Model, Dynamic time warping (DTW)-based speech recognition, a convolutional neural network (CNN) and a deep neural network (DNN).

The suitability unit 220 may output the suitability score 122 based on the plurality of attribute scores 114-1 to 114-n. The suitability score 122 may relate to an accuracy of a speech recognition system to transcribe or translate the data including audio from speech to text. For example, the suitability unit 220 may output one of a lowest score and a highest score of the plurality of attribute scores 114-1 to 114-n as the suitability score 122. In another example, the suitability unit 220 may combine the plurality of attribute scores 114-1 to 114-n to output the suitability score 122.

For instance, the suitability unit 220 may output an average and/or a weighted average of the plurality of attribute scores 114-1 to 114-n as the suitability score 122. In one example, the suitability unit 220 may inversely weight some of the attribute scores 114, such as the attribute scores 114 related to the SNR or bandwidth compared to a remainder of the plurality of attribute scores 114-1 to 114-n when determining the suitability score 122. This is because a higher attribute score 114 for such acoustic attributes 112 may indicate better sound quality while a higher attribute score 114 for the remainder of the acoustic attributes 112 may indicate worse sound quality.

The suitability score 122 may be represented according to a numerical and/or visual system. For instance, an example numerical system may include a scale of 1 to 5, where 5 indicates the lowest likelihood of accurate translation and 1 indicates the highest likelihood of accurate translation. The visual system may include a color coding scale, such as from green to red, where red indicates the lowest likelihood of accurate translation and green indicates the highest likelihood of accurate translation.

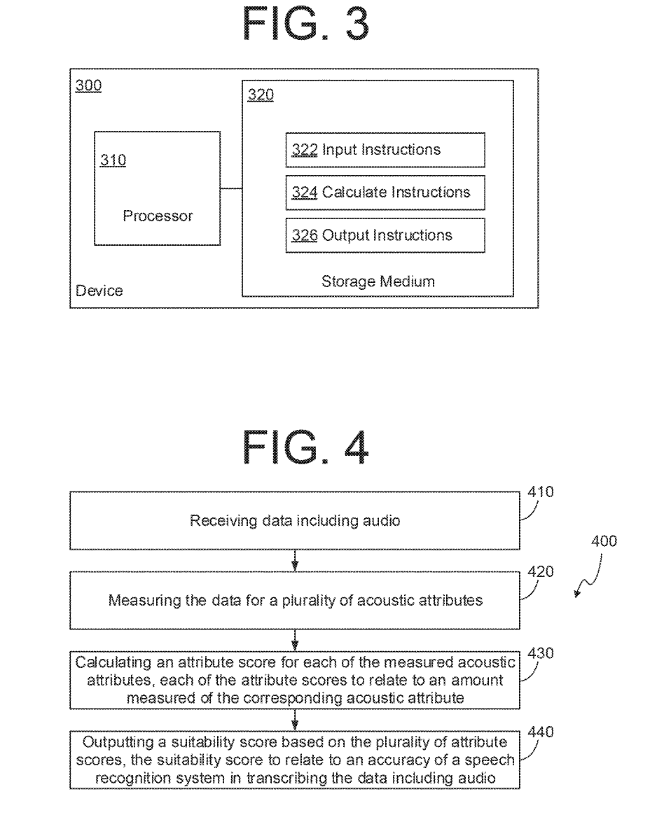

FIG. 3 is an example block diagram of a computing device 300 including instructions for outputting a accuracy score based on attribute scores. In the embodiment of FIG. 3, the computing device 300 includes a processor 310 and a machine-readable storage medium 320. The machine-readable storage medium 320 further includes instructions 322, 324 and 326 for outputting a suitability score based on attribute scores.

The computing device 300 may be included in or part of, for example, a microprocessor, a controller, a memory module or device, a notebook computer, a desktop computer, an all-in-one system, a server, a network device, a wireless device, or any other type of device capable of executing the instructions 322, 324 and 326. In certain examples, the computing device 300 may include or be connected to additional components such as memories, controllers, microphones etc.

The processor 310 may be, at least one central processing unit (CPU), at least one semiconductor-based microprocessor, at least one graphics processing unit (GPU), a microcontroller, special purpose logic hardware controlled by microcode or other hardware devices suitable for retrieval and execution of instructions stored in the machine-readable storage medium 320, or combinations thereof. The processor 310 may fetch, decode, and execute instructions 322, 324 and 326 to implement outputting the suitability score based on the attribute scores. As an alternative or in addition to retrieving and executing instructions, the processor 310 may include at least one integrated circuit (IC), other control logic, other electronic circuits, or combinations thereof that include a number of electronic components for performing the functionality of instructions 322, 324 and 326.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for outputting the suitability score based on the attribute scores.

Moreover, the instructions 322, 324 and 326, when executed by a processor (e.g., via one processing element or multiple processing elements of the processor) can cause the processor to perform processes, such as, the process of FIG. 4. For example, the input instructions 322 may be executed by the processor 310 to input data including audio into a plurality of attributes units. Each of the attributes units may measure for one of a plurality of acoustic attributes.

The calculate instructions 324 may be executed by the processor 310 to calculate for each of the attributes units, an attribute score in response to the inputted data. Each of the attribute scores may relate to an amount measured of the corresponding acoustic attribute. A higher value for any of the attribute scores may indicate a greater amount of the corresponding acoustic attribute.

The output instructions 326 may be executed by the processor 310 to output the suitability score based on the plurality of attribute scores. The suitability score may relate to an accuracy of a speech recognition system to transcribe the data including audio. A highest score of the plurality of attribute scores or an average the plurality of attribute scores may be outputted as the suitability score.

FIG. 4 is an example flowchart of a method 400 for outputting a suitability score based on attribute scores. Although execution of the method 400 is described below with reference to the device 200, other suitable components for execution of the method 400 can be utilized, such as the device 100. Additionally, the components for executing the method 400 may be spread among multiple devices (e.g., a processing device in communication with input and output devices). In certain scenarios, multiple devices acting in coordination can be considered a single device to perform the method 400. The method 400 may be implemented in the form of executable instructions stored on a machine-readable storage medium, such as storage medium 320, and/or in the form of electronic circuitry.

At block 410, the device 200 receives data including audio. At block 420, the device 200 measures the data for a plurality of acoustic attributes. At block 430, the device 200 calculates an attribute score 114 for each of the measured acoustic attributes 112-1 to 112-n. Each of the attribute scores 114 may relate to an amount measured of the corresponding acoustic attribute 112. The plurality of acoustic attributes 112-1 to 112-n may relate to at least one of an amount of bandwidth, clipping of an audio wave, music, speech, background noise, reverberation, and a signal-to-noise ratio (SNR) within the data including audio. At block 440, the device 200 outputs the suitability score 122 based on the plurality of attribute scores 114-1 to 114-n. The suitability score 122 may relate to an accuracy of a speech recognition system in transcribing the data including audio.

We claim:

1. A device, comprising:
an attribute unit to calculate a plurality of attribute scores for data including audio based on a plurality of acoustic attributes, each of the attribute scores to relate to a detection of one of the acoustic attributes in the data including audio; and
a suitability unit to output a suitability score based on the plurality of attribute scores, the suitability score to relate to an accuracy of a speech recognition system to transcribe the data including audio.

2. The device of claim 1, wherein the plurality of acoustic attributes relates to at least one of an amount of bandwidth, clipping of an audio wave, music, speech, background noise, reverberation, and a signal-to-noise ratio (SNR) within the data including audio.

3. The device of claim 2, wherein the suitability unit is to output one of a lowest score and a highest score of the plurality of attribute scores as the suitability score.

4. The device of claim 2, wherein the suitability unit is to combine the plurality of attribute scores to output the suitability score.

5. The device of claim 4, wherein the suitability unit is to output at least one of an average and a weighted average of the plurality of attribute scores as the suitability score.

6. The device of claim 5, wherein the suitability unit is to inversely weight the attribute score related to the SNR compared to a remainder of the plurality of attribute scores when determining the suitability score.

7. The device of claim 2, wherein,
a higher value for any of the attribute scores indicates a greater amount of the corresponding acoustic attribute,
the acoustic attribute related to SNR is to measure a ratio of an audio level of speech in decibels compared to a level of background noise, and
the acoustic attribute related to audio clipping is to measure a percentage of the waveform that is affected by clipping.

8. The device of claim 7, wherein,
the acoustic attribute related to audio bandwidth is to measure at least one of bitrate, an amount of compression, upsampling and an amount of lower bandwidth compared within a greater bandwidth within the data including the audio, and
the acoustic attribute related to speech is to measure at least one of a type of language detected and a type of accent of a speaker within the data including the audio

9. The device of claim 2, wherein
the attribute unit is to identify the plurality of acoustic attributes within the data including the audio based on at least one of a plurality of acoustic units and a neural network, and
each of the plurality of acoustic units is to identify one of the acoustic attributes and to output the attribute score based on an amount of the corresponding acoustic attribute that is identified.

10. The device of claim 9, wherein,
the attribute unit is to convert the data including the audio into a time sequence of acoustic feature vectors and to input the time sequence to the neural network, and
the neural network is to output the suitability score at periodic time intervals,

11. The device of claim 2, wherein,
the suitability score is represented according to at least one of a numerical and visual system,
the visual system includes a color coding scale, and
the data includes at least one of a video and audio segment.

12. A method, comprising:
receiving data including audio;
measuring the data for a plurality of acoustic attributes;
calculating an attribute score for each of the measured acoustic attributes, each of the attribute scores to relate to an amount measured of the corresponding acoustic attribute; and
outputting a suitability score based on the plurality of attribute scores, the suitability score to relate to an accuracy of a speech recognition system in transcribing the data including audio.

13. The method of claim 12, wherein the plurality of acoustic attributes relates to at least one of an amount of bandwidth, clipping of an audio wave, music, speech, background noise, reverberation, and a signal-to-noise ratio (SNR) within the data including audio.

14. A non-transitory computer-readable storage medium storing instructions that, if executed by a processor of a device, cause the processor to:
input data including audio into a plurality of acoustic units, each of the attributes units to measure for one of a plurality of acoustic attributes;
calculate for each of the acoustic units, an attribute score in response to the inputted data, each of the attribute scores to relate to an amount measured of the corresponding acoustic attribute; and
output a suitability score based on the plurality of attribute scores, the suitability score to relate to an accuracy of a speech recognition system to transcribe the data including audio.

15. The non-transitory computer-readable storage medium of claim 14, wherein,
a higher value for any of the of attribute scores indicates a greater amount of the corresponding acoustic attribute, and
one of a highest score of the plurality of attribute scores and an average the plurality of attribute scores is outputted as the suitability score.
